(19) United States
(12) Patent Application Publication
(10) Pub. No.: US 2014/0166839 A1
(43) Pub. Date: Jun. 19, 2014

(54) ENCLOSURE SUPPORTER

(71) Applicants: Hon Hai Precision Industry Co., Ltd., New Taipei (TW); Hong Fu Jin Precision Industry (WuHan) Co., Ltd., Wuhan (CN)

(72) Inventors: CHUNG CHAI, New Taipei (TW); ZHI-QIANG LI, Wuhan (CN); CHANG-KE KE, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/972,865

(22) Filed: Aug. 21, 2013

(30) Foreign Application Priority Data
Dec. 18, 2012 (CN) 2012105508321

(51) Int. Cl. F16M 11/20

(52) U.S. Cl. CPC F16M 11/20
USPC 248/346.3

(57) ABSTRACT

An enclosure supporter includes a mounting member and two sliding members slidably mounted to the mounting member. The mounting member includes a panel body and a gear pivotally mounted to the panel body. Each of the two sliding members includes a rack engaging with the gear. The two racks are substantially parallel to each other and the gear is positioned between the two racks. The two sliding members are slidable along opposite directions substantially parallel to the rack due to the engagement between the gear and the two racks.

### BACKGROUND

1. Technical Field

The present disclosure relates to a supporter for supporting an enclosure.

2. Description of Related Art

A computer usually includes an enclosure and a number of supporters mounted to the bottom portion of the enclosure. The supporters are formed as protrusions. However, the enclosure may not keep balance on a plane because of this kind of supporter.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of an enclosure supporter and an enclosure.

FIG. 2 is an exploded, isometric view of an enclosure supporter of FIG. 1.

FIG. 3 is similar to FIG. 2, but viewed from another aspect.

FIG. 4 is an assembled view of the enclosure supporter of FIG. 2.

FIG. 5 is a platform view of FIG. 4.

FIG. 6 is another platform view of FIG. 4, the enclosure supporter being unfolded.

FIG. 7 is an assembled view of FIG. 1.

FIG. 8 is another assembled view of FIG. 1, the enclosure supporter being unfolded.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

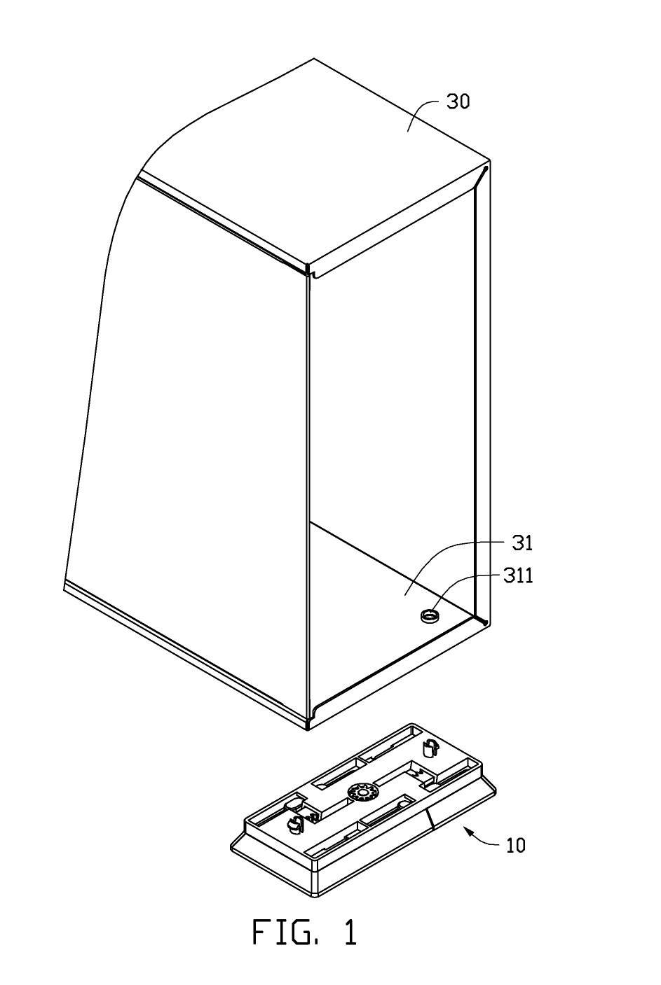

FIG. 1 shows an enclosure supporter 10 according to one embodiment. The enclosure supporter 10 is used for supporting an enclosure 30. The enclosure 30 includes a bottom panel 31. The bottom panel 31 defines two engaging holes 311.

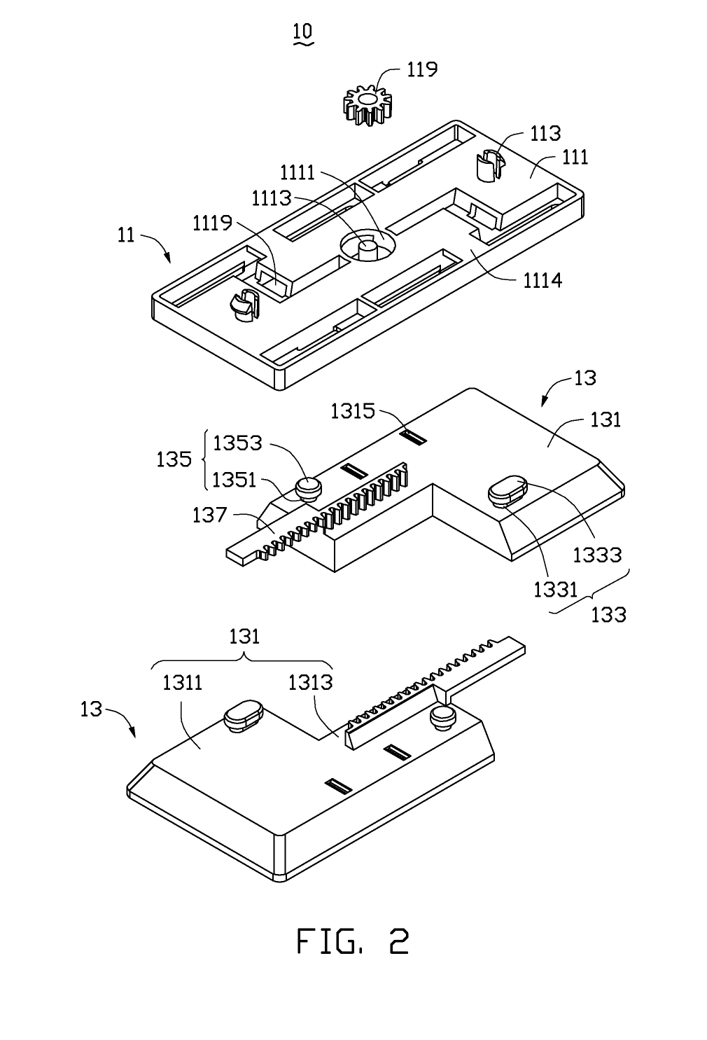

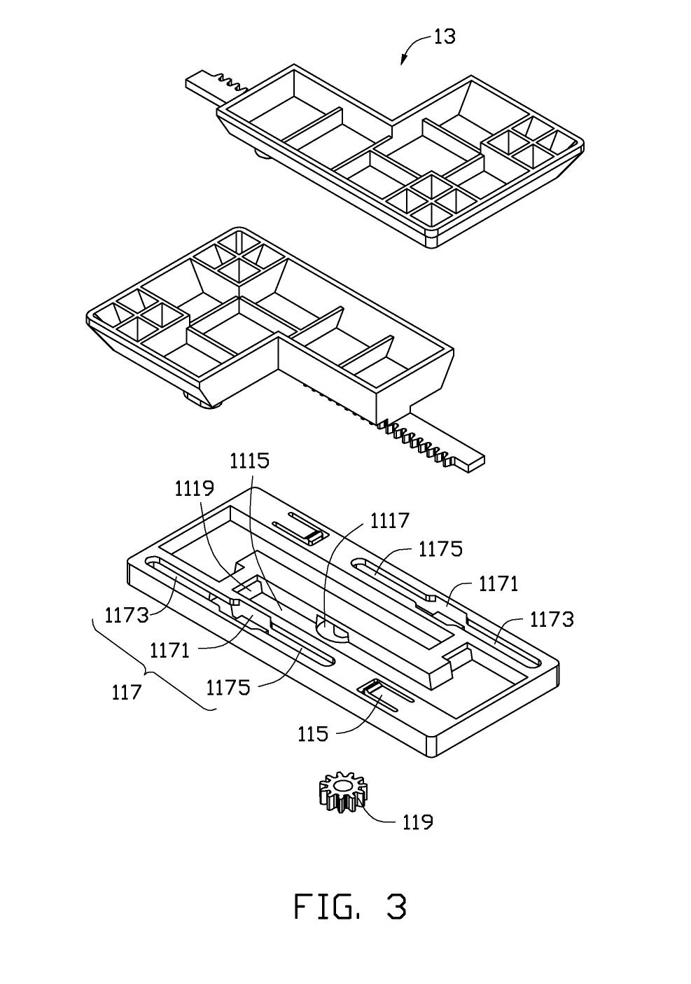

FIGS. 2 and 3 show that the enclosure supporter 10 includes a mounting member 11 and two sliding members 13. The mounting member 11 includes a panel body 111 and two engaging portions 113, extending from an upper side 1110 of the panel body 111. The mounting member 11 includes two engaging tabs 115 extending from a lower side 1112 of the panel body 111. The upper side 1110 is substantially parallel to the lower side 1112. The panel body 111 defines a recess portion 1111. The mounting member 11 further includes a rotating shaft 1113 extending from the bottom portion of the recess portion 1111. The panel body 111 defines two sliding slots 1115 recessed from the lower side 1112. Each sliding slot 1115 communicates with the recess portion 1111 via a connecting opening 1117. Each sliding slot 1115 communicates with a positioning opening 1119. The panel body 111 further defines two mounting slots 117 in the lower side 1112. Each mounting slot 117 defines a wide part 1171, a first narrow part 1173 communicating with the wide part 1171, and, a second narrow part 1175 communicating with the wide part 1171. The first narrow part 1173 and the second narrow part 1175 are located on opposite sides of the wide part 1171. The first narrow part 1173 and the second narrow part 1175 pass through the upper side 1110 and the lower side 1112. A separating portion 1114 is located on the upper side 1110 corresponding to the wide part 1171. The mounting member 11 further includes a gear 119 pivotally mounted to the rotating shaft 1113.

Each sliding member 13 includes a main body 131 and a first sliding portion 133, a second sliding portion 135, and a rack 137 for engaging with the gear 119. The first sliding portion 133, the second sliding portion 135, and the rack 137 extend from the main body 131. The extending direction of the rack 137 is substantially parallel to the extending direction of the first narrow part 1173.

The main body 131 includes a wide portion 1311 and a narrow portion 1313 extending from the wide portion 1311. The main body 131 is L-shaped. The rack 137 is mounted to the main body 131. The first sliding portion 133 includes a first neck portion 1331, extending from the wide portion 1311 of the main body 131, and a first head portion 1333, extending from the first neck portion 1331. The second sliding portion 135 includes a second neck portion 1351, extending from the narrow portion 1313 of the main body 131, and a second head portion 1353, extending from the second neck portion 1351. The main body 131 defines two engaging openings 1315 corresponding to the engaging tabs 115.

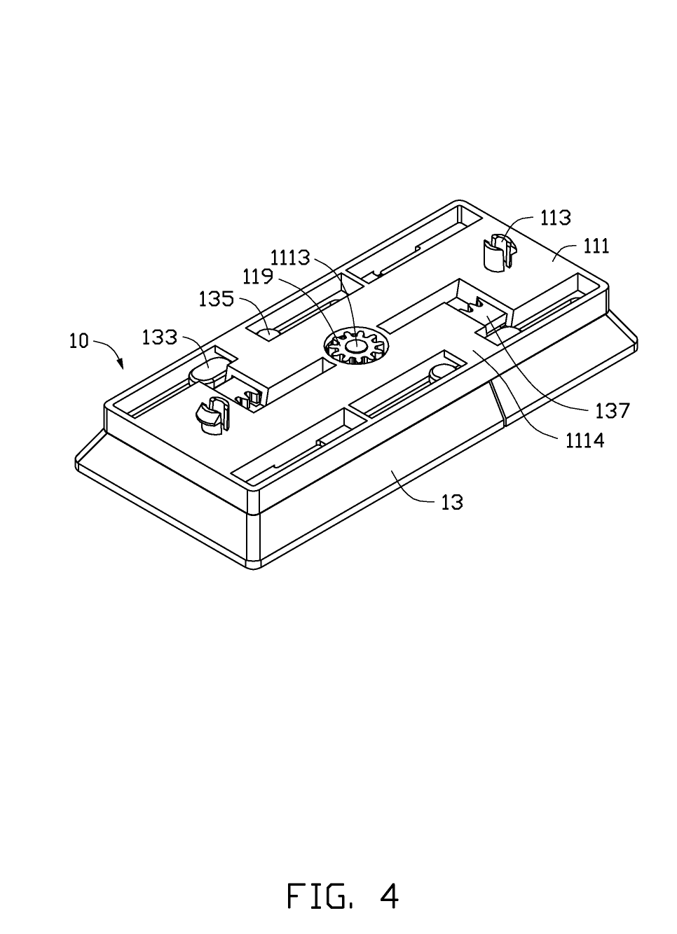

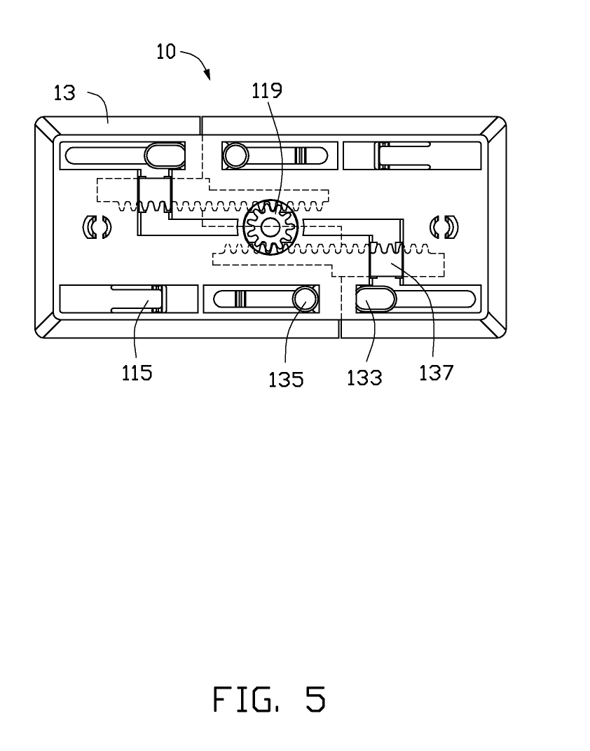

FIGS. 4 and 5 show that in assembly of the enclosure supporter 10, the rack 137 of one of the sliding members 13 is mounted in the sliding slot 1115 of the mounting member 11, to pass through the positioning opening 1119. The first sliding portion 133 and the second sliding portion 135 are placed in the two wide parts 1171 of the two mounting slots 117. The first sliding portion 133 moves a distance to be positioned in the first narrow part 1173, to enable the main body 131 to contact the mounting member 11. The first sliding portion 133 is positioned in the first narrow part 1173 to contact an edge of the separating portion 1114. At this time, the second sliding portion 135 is positioned in the second narrow part 1175 of another mounting slot 117. A part of the rack 137 is received in recess portion 1111 via the connecting opening 1117. Another sliding member 13 is mounted to the mounting member 11 according to the above steps. At this time, the two racks 137 are substantially parallel to each other. The two engaging tabs 115 engage in the engaging openings 1315. The gear 119 is pivotally mounted to the rotating shaft 1113 to engage the two racks 137.

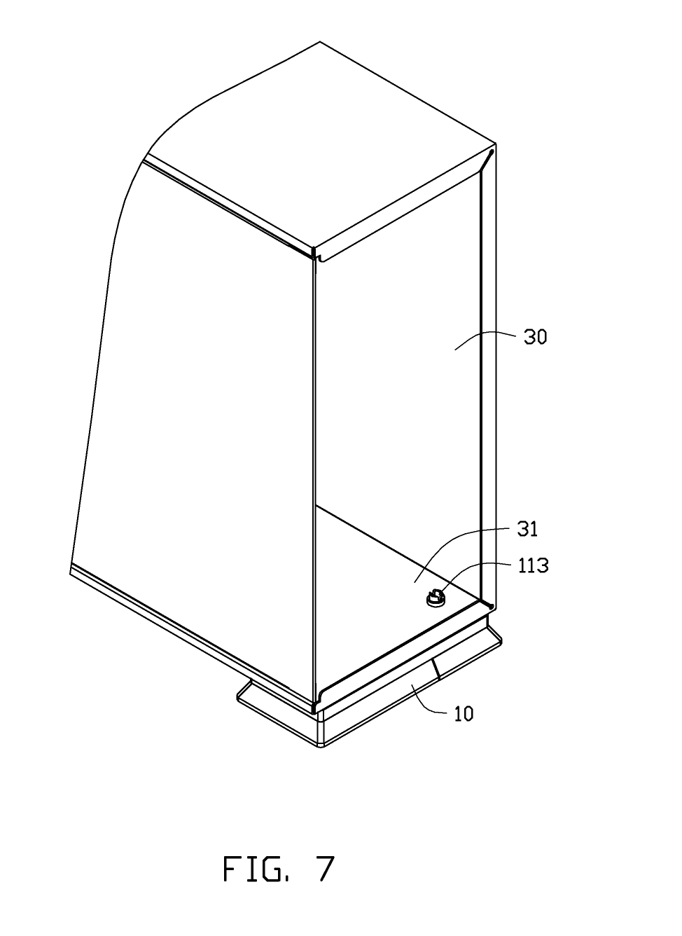

FIG. 7 shows that the two engaging portions 113, of the enclosure supporter 10, correspond to the engaging holes 311 of the enclosure 30. The enclosure supporter 10 moves to the bottom panel 31 of the enclosure 30 to enable the two engaging portions 113 to engage in the two engaging holes 311, thereby securing the enclosure supporter 10 to the enclosure 30.

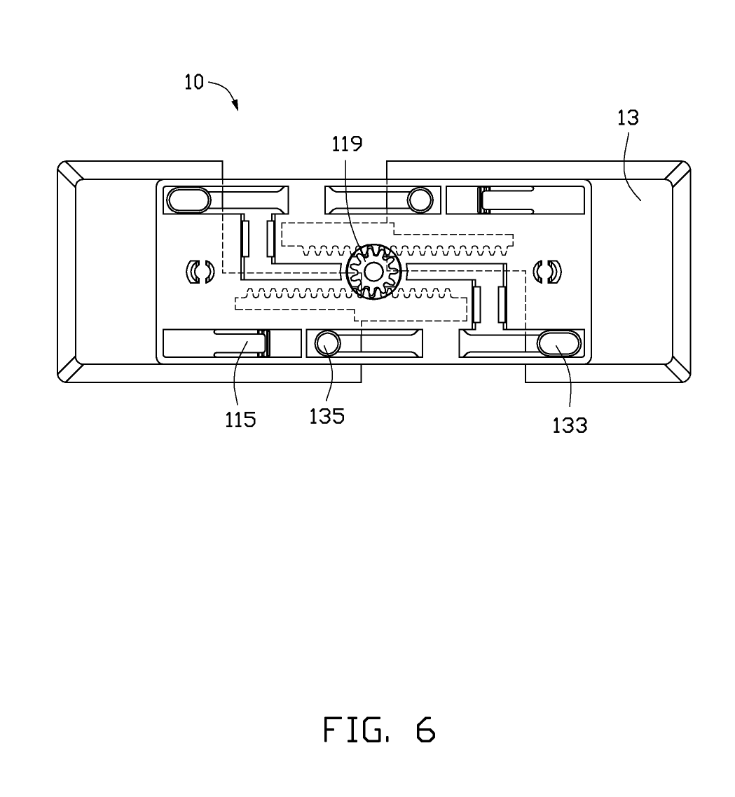

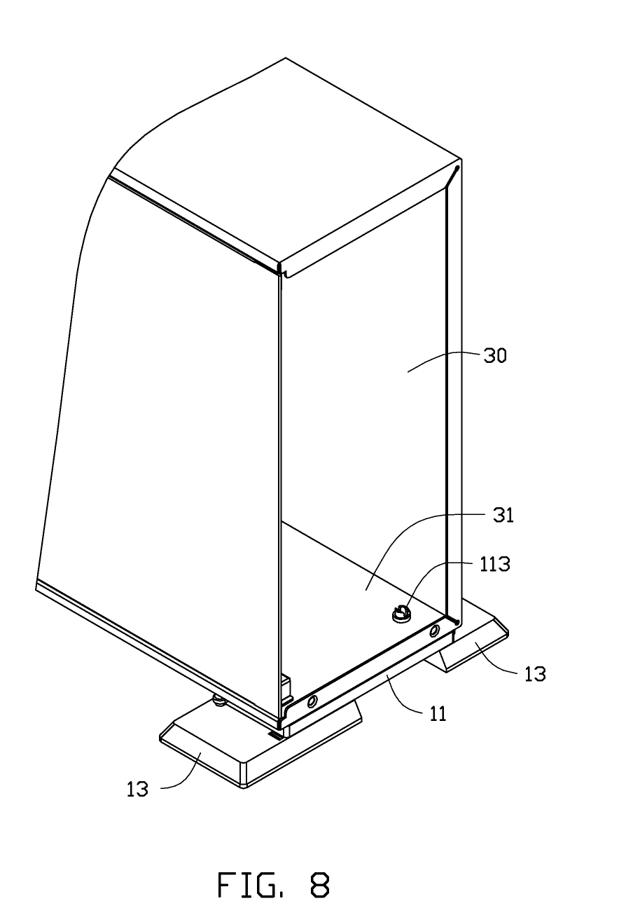

FIGS. 6 and 8 show that in use, one of the sliding members 13 is pulled outwards along a first direction. The first sliding portion 133 of the sliding member 13 1 slides in the first narrow part 1173 of the mounting slot 117. The second sliding portion 135 slides in the second narrow part 1175 of another mounting slot 117. The rack 137 of the sliding member 13 drives the gear 119 to rotate, thereby driving another sliding member 13 to move outward along a second direction substantially opposite to the first direction. The enclosure supporter 10 is thus unfolded to support the enclosure 30. At this time, the two engaging tabs 115 engage in the engaging openings 1315.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An enclosure supporter, comprising:
a mounting member, the mounting member comprises a panel body and a gear pivotally mounted to the panel body; and
two sliding members slidably mounted to the mounting member; each of the two sliding members comprises a rack engaging with the gear; the two racks are substantially parallel to each other, and the gear is positioned between the two racks; and the two sliding members are slidable relative to the mounting member in opposite directions due to engagement between the gear and the two racks.

2. The enclosure supporter of claim 1, wherein the panel body comprises an upper side and a rotating shaft; the upper side defines a recess portion, and the rotating shaft extending from a bottom portion of the recess portion; the gear is pivotally mounted to the rotating shaft; the recess portion defines two connecting openings; and the two racks engage with the gear via the two connecting openings.

3. The enclosure supporter of claim 2, wherein the panel body further comprises a lower side; the panel body defines two sliding slots in the lower side; each of the two sliding slots communicates with the recess portion via one of the two positioning openings; and the two racks are positioned in the two sliding slots and received in the two positioning openings.

4. The enclosure supporter of claim 1, wherein each of the two sliding members comprises a main body and a first sliding portion, extending from the main body; the rack is mounted on the main body; the panel body defines two mounting slots; each of the two mounting slots defines a wide part and a first narrow part communicating with the wide part; and the first sliding portion is configured to slide in the first narrow part of one of the two mounting slots via the wide part.

5. The enclosure supporter of claim 4, wherein each of the two sliding members further comprises a second sliding portion extending from the main body; each of the two mounting slots further defines a second narrow part communicating with the wide part; and the second sliding portion is configured to slide in the second narrow part of the other one of the two mounting slots via the wide part, when the first sliding portion slides in the first narrow part of the one of the two mounting slots.

6. The enclosure supporter of claim 5, wherein the main body comprises a wide portion and a narrow portion extending from the wide portion; the first sliding portion extends from the wide portion; and the second sliding portion extends from the narrow portion.

7. The enclosure supporter of claim 5, wherein the first narrow part and the second narrow part extend along opposite directions from the wide part.

8. The enclosure supporter of claim 5, wherein the main body is L-shaped.

9. The enclosure supporter of claim 5, wherein the rack extends from the narrow portion.

10. The enclosure supporter of claim 4, wherein the each first sliding portions comprises a first neck portion, extending from the main body, and a first head portion, extending from the first neck portion; and the first head portion is configured to pass through the wide part to enable the first neck portion to be positioned in the first narrow part.

11. An enclosure supporter assembly, comprising:
an enclosure, the enclosure comprise a bottom panel having an engaging hole;
a mounting member, the mounting member comprises a panel body, an engaging portion extending from the panel body, a gear pivotally mounted to the panel body; and the engaging portion engages in the engaging hole to enable the panel body to contact the bottom panel; and
two sliding members slidably mounted to the mounting member to enable the panel body to be positioned between the bottom panel and the two sliding members; each of the two sliding members comprises a rack engaging with the gear; the two racks are substantially parallel to each other and the gear is positioned between the two racks; and the two sliding members is slidable relative to the mounting member in opposite directions due to engagement between the gear and the two racks.

12. The enclosure supporter assembly of claim 11, wherein the panel body comprises an upper side; the upper side defines a recess portion, the panel body comprises a rotating shaft extending from a bottom portion of the recess portion; the gear is pivotally mounted to the rotating shaft; the recess portion defines two connecting opening; and the two racks engage with the gear via the two connecting opening.

13. The enclosure supporter assembly of claim 12, wherein the panel body further comprises a lower side; the panel body defines two sliding slots in the lower side; each of the two sliding slots communicates with the recess portion via one of the two positioning openings; and the two racks are positioned in the two sliding slots and are received in the two positioning openings.

14. The enclosure supporter assembly of claim 11, wherein each of the two sliding members comprises a main body and a first sliding portion extending from the main body; the rack is mounted on the main body; the panel body defines two mounting slots; each of the two mounting slots defines a wide part and a first narrow part communicating with the wide part; and the first sliding portion is configured to slide in the first narrow part of one of the two mounting slots via the wide part.

15. The enclosure supporter assembly of claim 14, wherein each of the two sliding members further comprises a second sliding portion extending from the main body; each of the two mounting slots further defines a second narrow part communicating with the wide part; the second sliding portion is configured to slide in the second narrow part of the other one of the two mounting slots via the wide part when the first sliding portion slides in the first narrow part of the one of the two mounting slots.

16. The enclosure supporter assembly of claim 15, wherein the main body comprises a wide portion and a narrow portion extending from the wide portion; the first sliding portion extends from the wide portion; and the second sliding portion extending from the narrow portion.

17. The enclosure supporter assembly of claim 15, wherein the first narrow part and the second narrow part extend along opposite direction from the wide part.

18. The enclosure supporter assembly of claim 15, wherein the main body is L-shaped.

19. The enclosure supporter assembly of claim 16, wherein the rack extends from the narrow portion.

20. The enclosure supporter assembly of claim 14, wherein the each first sliding portion comprises a first neck portion extending from the main body and a first head portion extending from the first neck portion; the first head portion is configured to pass through the wide part to enable the first neck portion to be positioned in the first narrow part.
